(19) United States
(12) Patent Application Publication
(10) Pub. No.: US 2025/0310433 A1
(43) Pub. Date: Oct. 2, 2025

(54) RADIO COMMUNICATION DEVICE AND METHOD OF CONTROLLING RADIO COMMUNICATION DEVICE

(71) Applicant: JVCKENWOOD Corporation, Yokohama-shi (JP)

(72) Inventors: Masao Ubukata, Yokohama-shi (JP); Ryohei Sunaga, Yokohama-shi (JP)

(21) Appl. No.: 19/238,599

(22) Filed: Jun. 16, 2025

Related U.S. Application Data
(63) Continuation of application No. PCT/JP2023/036699, filed on Oct. 10, 2023.

(30) Foreign Application Priority Data
Dec. 22, 2022 (JP) 2022-205956
Jul. 24, 2023 (JP) 2023-120116

(51) Int. Cl. H04M 1/72454

(52) U.S. Cl. CPC H04M 1/72454

(57) ABSTRACT

A radio communication device and a method of controlling a radio communication device that enable a voice call between users appropriately are provided. The radio communication device according to the disclosure includes a sound acquisition unit that acquires sound that is acquired by a microphone that acquires sound of utterance of a user; a communication controller that transmits the sound that is acquired by the sound acquisition unit to another device that is set previously; a detector that detects that an environment of the user is an environment with a heavy physical load on the user; and a restriction processor that restricts transmission of the sound that is acquired by the sound acquisition unit, which is transmission performed by the communication controller, when the detector detects that it is an environment with a heavy physical load on the user.

### CROSS-REFERENCE TO RELATED APPLICATIONS

This application is a Continuation of PCT International Application No. PCT/JP2023/036699 filed on Oct. 10, 2023 which claims the benefit of priority from Japanese Patent Application No. 2022-205956 filed on Dec. 22, 2022 and Japanese Patent Application No. 2023-120116 filed on Jul. 24, 2023, the entire contents of all of which are incorporated herein by reference.

### BACKGROUND OF THE INVENTION

### 1. Field of the Invention

The present disclosure relates to a radio communication device and a method of controlling a radio communication device.

### 2. Description of the Related Art

When multiple persons are cycling, voice calls are made by radio communication in some cases in order to make mutual communications. For example, Japanese Laid-open Patent Publication No. 2017-123640 discloses a technology of making radio communications between persons riding two-wheelers using helmets for two-wheelers.

A radio communication system described in Japanese Laid-open Patent Publication No. 2017-123640 includes a plurality of helmets and a plurality of radio communication devices that are arranged in the helmets and achieves an effect of long-distance communication by multi-hop communication of transmitting a communication request signal by broadcasting by a relay unit, sequentially transmitting the communication request signal via a multi-hop communication function in a short-distance communication area, and transmitting the communication request signal to a broadcasting partner.

Such a communication device using radio keeps transmitting and receiving sound in many cases. For this reason, appropriate communications can be made; however, for example, when the physical load of the riders is heavy as in climbing an uphill, the communication partner sometimes hears respiratory sounds loudly. For example, switching between speaking and listening by a manual operation as with a push to talk (PTT) switch is assumable; however, when the physical load is high, it is not appropriate to relay on the operation by the user in view of emergency.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A radio communication device according to the present disclosure comprising: a sound acquisition unit that acquires sound that is acquired by a microphone that acquires sound of utterance of a user; a communication controller that transmits the sound that is acquired by the sound acquisition unit to another device that is set previously; a detector that detects that an environment of the user is an environment with a heavy physical load on the user; and a restriction processor that restricts transmission of the sound that is acquired by the sound acquisition unit, which is transmission performed by the communication controller, when the detector detects that it is an environment with a heavy physical load on the user.

A radio communication device comprising: a communication controller that receives, from another device that is set previously, sound that is acquired by a microphone of the another device and information indicating that an environment of the user of the another device is an environment with a heavy physical load on the user; and a sound output unit that outputs the sound that is received by the communication controller, wherein the sound output unit restricts output of the sound when the information indicating that it is an environment with a heavy physical load on the user is received.

### BRIEF DESCRIPTION OF THE DRAWINGS

FIG. 1 is a schematic diagram illustrating an example of a scene where a radio communication device according to the disclosure is used;

FIG. 2 is a diagram illustrating an example of a configuration of a radio communication system according to the disclosure;

FIG. 3 is a diagram illustrating an example of a configuration of a first embodiment of the radio communication device according to the disclosure;

FIGS. 4A and 4B are a diagram illustrating an example of a process performed by a restriction processor of the radio communication apparatus according to the disclosure;

FIG. 5 is a flowchart illustrating a flow of a method of controlling the radio communication device according to the disclosure;

FIG. 6 is a diagram illustrating an example of a configuration of a second embodiment of the radio communication device according to the disclosure; and

FIG. 7 is a flowchart illustrating a flow of a method of controlling the radio communication device according to the disclosure.

### DETAILED DESCRIPTION OF THE PREFERRED EMBODIMENTS

An embodiment of the disclosure will be described in detail below according to the accompanying drawings. Note that the embodiment described below do not limit the disclosure.

### Overview of Radio Communication Device

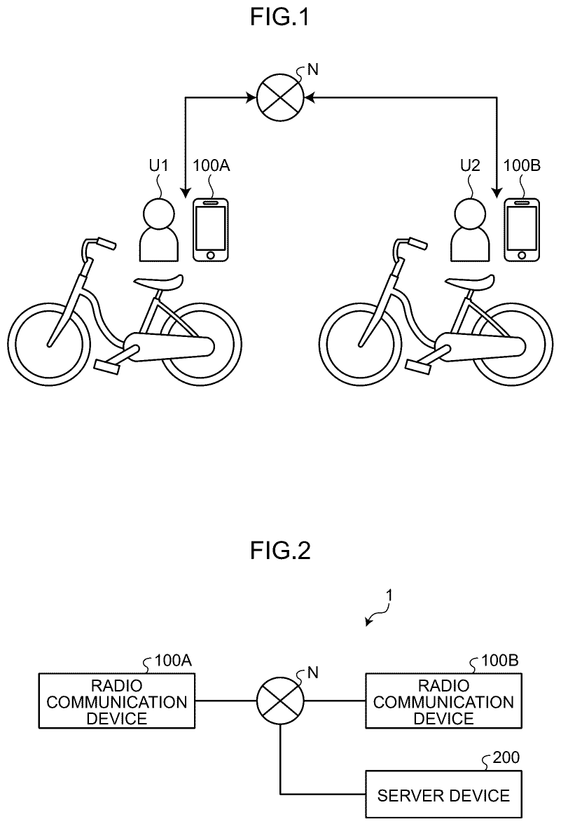

First of all, using FIG. 1, an example of a scene where a radio communication device 100 according to the disclosure is used will be described. FIG. 1 is a schematic diagram illustrating the example of the scene where the radio communication device according to the disclosure is used. As illustrated in FIG. 1, the radio communication device 100 is used by a user to communicate with another user while riding a bicycle. FIG. 1 simply illustrates the example where two users use the radio communication devices 100; however, three or more users may use the radio communication devices 100 simultaneously. Such a case corresponds to the case where, using the radio communication devices 10 used by a plurality of users, voice calls are made simultaneously among all the users.

The scene where the radio communication device 100 is used is not limited to the scene of use illustrated in FIG. 1. For example, the radio communication device 100 may be used to communicate with another user while the user is running with the another user or may be used to communicate with another user while the user is climbing a mountain or is trekking with the another user.

### Configuration of Radio Communication System

a radio communication system 1 according to the disclosure will be described next using FIG. 2. FIG. 2 is a diagram illustrating an example of a configuration of the radio communication system according to the disclosure. As illustrated in FIG. 2, the radio communication system 1 according to the disclosure includes the radio communication device 100, a server device 200, and a network N. These configurations thereof will be described simply and sequentially below. FIG. 2 illustrates the case where the radio communication device 100 uses a public radio communication network as the network N; however, communications may be made between the radio communication devices 100 not via the server device 200, or the like. The public radio communication network is, for example, a network configured using radio communication using mobile communication services that are provided by a mobile communication service provider. Communication between the radio communication devices 100 is communication by Bluetooth (trademark), digital convenience radio communication, or the like.

The radio communication device 100 transmits and receives sound by radio to and from another radio communication device 100. When the radio communication device 100 is a radio communication device that uses a public wireless communication network, for example, the radio communication device 100 is configured using a digital simple radio communication device, a headset, etc.

The server device 200 is an information processing device that performs various types of information provision based on a request of an external device. The server device 200 is, for example, a server device that is run to manage the radio communication network. The server device 200 may be a distributed server device.

The network N is a radio communication network that connects the radio communication device 100 (100A), another radio communication device (100B), and the server device 200.

### Configuration of Radio Communication Device

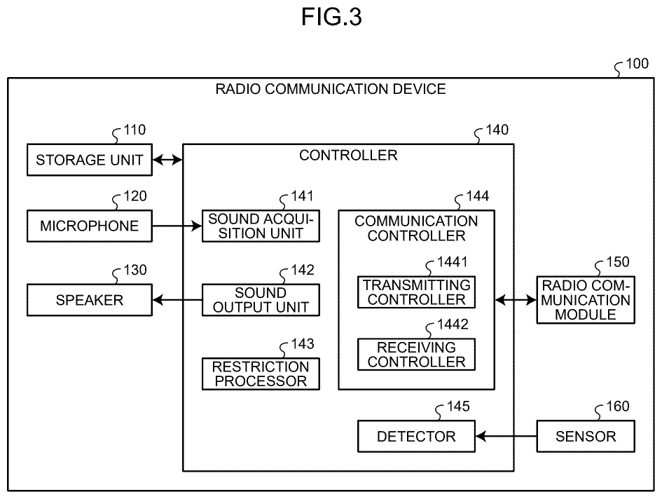

FIG. 3 is a diagram illustrating an example of a configuration of a first embodiment of the radio communication device according to the disclosure. As illustrated in FIG. 3, the radio communication device 100 according to the disclosure includes a storage unit 110, a microphone 120, a speaker 130, a controller 140, a radio communication module 150, and a sensor 160.

The storage unit 110 is a storage device that stores various types of information. For example, map information may be stored in the storage unit 110. The storage unit 110 may be realized using a main storage device and an auxiliary storage device. The main storage device may be realized using a semiconductor memory device, such as a random access memory (RAM), a read only memory (ROM), or a flash memory. The auxiliary storage device may be realized using, for example, a memory card, a solid state drive (SSD), or the like.

The microphone 120 collects various types of sound. The microphone 120, for example, collects voice of a user whose uses the radio communication device 100. The microphone 120, for example, collects environmental sound around the radio communication device 100. In the case where the radio communication device 100 is worn on a helmet to be worn by the user or the like, when the user wears the helmet, the microphone 120 is arranged in a position near the mouth of the user. In the case where the radio communication device 100 is configured by connecting an earphone, or the like, to the radio communication device 100, the microphone 120 is arranged in the earphone.

The speaker 130 outputs various types of sound. The speaker 130, for example, outputs voice of the user of another radio communication device 100. In the case where the radio communication device 100 is worn on a helmet to be worn by the user, when the user wears the helmet, the speaker 130 is arranged in a position where the speaker 130 does not cover the ears of the user. In the case where the radio communication device 100 is configured by connecting an earphone, or the like, to the radio communication device 100, the speaker 130 is configured using an earphone, or the like.

The controller 140 is a controller that controls the radio communication device 100. The controller 140 is realized by a central processing unit (CPU), a micro processing unit (MPU), or the like, by executing various types of programs that are stored in the storage unit 110 using a RAM as a work area. The controller 140 may be realized using an integrated circuit, such as an application specific integrated circuit (ASIC), a field programmable gate array, or the like.

As illustrated in FIG. 3, the controller 140 includes a sound acquisition unit 141, a sound output unit 142, a restriction processor 143, a communication controller 144, and a detector 145 as functions that are realized by execution of programs, a circuit configuration, and the like. Note that the controller 140 may execute these processes using a single CPU or may include a plurality of CPUs and the CPUs may execute the processes in parallel. The configurations thereof will be described sequentially.

The sound acquisition unit 141 acquires sound that is collected by the microphone 120 that collects sound of utterance of the user. In other words, the sound acquisition unit 141 detects the sound of utterance of the user.

The sound output unit 142 causes the speaker 130 to output the sound that is received from the another radio communication device 100. Note that, when a mute control instruction is transmitted from the restriction processor 143, the sound output unit 142 causes the speaker 130 not to output the sound that is received from the another radio communication device 100.

When the detector 145 detects that it is an environment with a heavy physical load on the user, the restriction processor 143 restricts transmission of the sound that is acquired by the sound acquisition unit 141, which is transmission performed by a transmitting controller 1441.

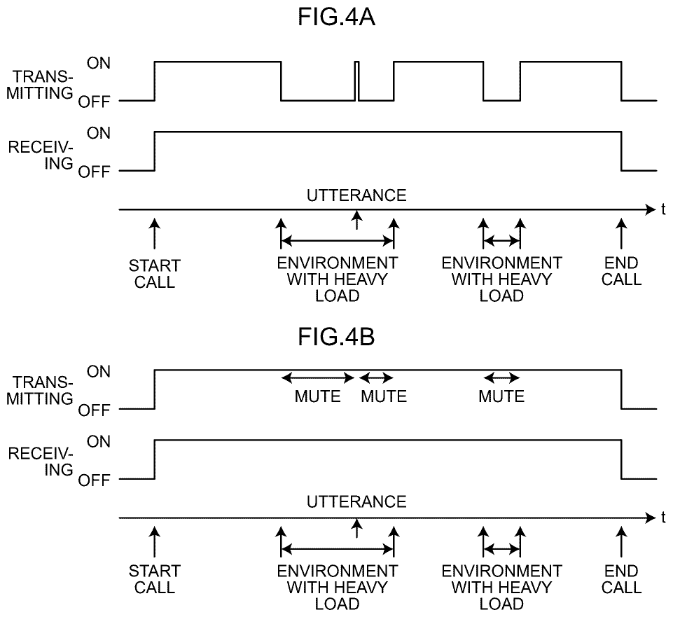

Using FIG. 4, a process performed by the restriction processor 143 will be described here. FIG. 4 is a diagram illustrating an example of the process performed by the restriction processor of the radio communication device according to the disclosure. As illustrated in FIG. 4, when the detector 145 detects that it is an environment with a heavy physical load on the user, the restriction processor 143 controls transmission of the sound that is acquired by the sound acquisition unit 141, which is transmission performed by the transmitting controller 1441. Specifically, as illustrated in an upper graph (a) in FIG. 4A, each time the detector 145 detects that it is an environment with a heavy physical load on the user, the transmitting controller 1441 performs control of switching off transmission of the sound that is acquired by the sound acquisition unit 141, that is, not transmitting sound, thereby restricting transmission of sounds.

As illustrated in a lower graph (b) in FIG. 4B, when the detector 145 detects that it is an environment with a heavy physical load on the user, with transmission of sounds performed by the transmitting controller 1441 being continued, the restriction processor 143 mutes a sound signal that is input to the transmitting controller 1441. In other words, the transmitting controller 1441 enters a state where the transmitting controller 1441 transmits a no-sound signal. Muting in this case includes, in addition to turning the volume of sound to be transmitted to zero, reducing the volume of sound to be transmitted.

The communication controller 144 controls radio communication performed by the radio communication device 100. As illustrated in FIG. 3, the communication controller 144 includes the transmitting controller 1441 and a receiving controller 1442.

The transmitting controller 1441 transmits the sound that is acquired by the sound acquisition unit 141 to another radio communication device 100 that is set previously. In other words, the transmitting controller 1441 transmits the sound that is acquired by the sound acquisition unit 141 via the server device 200 or directly to the another radio communication device 100 that is set previously. Identifying numbers of other radio communication devices 100 may be stored in the storage unit 110 and the sound that is acquired by the sound acquisition unit 141 may be transmitted at the same time to those other radio communication devices 100. The another radio communication device 100 that is set previously is another radio communication device 100 in which a setting for making a voice call is made and with which a voice call can be made.

Note that the transmitting controller 1441 restricts transmission of sound to the another radio communication device 100 according to a control command of the restriction processor 143. In other words, when the detector 145 detects that it is an environment with a heavy physical load on the user, the transmitting controller 1441 restricts transmission of the sound that is acquired by the sound acquisition unit 141 according to a control command of the restriction processor 143.

The receiving controller 1442 controls reception of the sound that is transmitted from the another radio communication device 100. For example, the receiving controller 1442 may perform control such that the receiving controller 1442 receives the sound that is transmitted from the another radio communication device 100 that is set previously.

By the transmitting controller 1441 and the receiving controller 1442, the communication controller 144 makes a voice call with the another radio communication device 100. The another radio communication device 100 may be single or include a plurality of radio communication devices. A voice call in the embodiment refers to transmitting and receiving sound of utterance to and from all other radio communication devices 100 that are set previously by keeping transmitting and receiving sound to and from the radio communication devices 100.

The detector 145 detects that the environment of the user is an environment with a heavy physical load on the user. The detector 145, for example, detects that the person walking or running while using the radio communication device 100 or the bicycle with the person riding thereon is moving in a direction in which the user climbs an uphill from information of a gyro sensor or an acceleration sensor that is the sensor 160. In other words, the detector 145 detects the user's climbing an uphill in the state of waling or riding the bicycle as an environment with a heavy physical load.

The detector 145 detects the user's climbing an uphill as an environment with a heavy physical load on the user. For example, when the radio communication device 100 is mounted on a bicycle, the detector 145 detects a change in the direction of acceleration of gravity from being straight down to being backward with respect to the bicycle as traveling an uphill.

The detector 145 detects that the person with the radio communication device 100 is running from the information of the gyro sensor or the acceleration sensor of the sensor 160. In other words, the detector 145 detects the user's running (in other words, traveling at a speed of walking or higher) as an environment with a heavy physical load.

The detector 145 may detect that the environment of the user is an environment with a heavy physical load on the user while the communication controller 144 is making a voice call with the another radio communication device 100. In other words, the communication controller 144 starts a voice call with the another radio communication device and accordingly the detector 145 starts detecting that the environment of the user is an environment with a heavy physical load on the user.

The radio communication module 150 executes mutual radio communication with the server device 200 or the another radio communication device. The radio communication module 150 is, for example, a radio communication module for performing radio communication by Wi-Fi (trademark), 5G, or the like, or a radio communication module for performing medium-distance radio communication by Bluetooth or digital simple radio communication.

The sensor 160 measures information on the physical environment of the user. The sensor 160 may be a gyro sensor or an acceleration sensor. In a gyro sensor, primary oscillation that is oscillation in one direction is caused in a movable electrode and, when rotation is added to the movable electrode, Coriolis force works in a direction of oscillation and a direction of 90 degrees and accordingly secondary oscillation occurs and a change in capacitance occurs and therefore a capacitance micro electro mechanical systems (MEMS) gyro sensor that detects the change may be used. Note that it is possible to calculate an angular velocity using the change in capacitance and an oscillation phase of the movable electrode. The acceleration sensor, for example, may be a capacitive acceleration sensor in which a movable electrode and a fixed electrode are made using a MEMS and an acceleration is measured using a relationship between the change in capacitance caused by the movable electrode's moving and the acceleration.

For example, a device that the user wears, such as a smart watch, may be used as the sensor 160. In other words, the sensor 160 may be replaced with a function of a device worn by the user and the function of the device that the user wears may be used complementarily for the sensor 160 that the radio communication device 100 includes. Using such a device makes it possible to acquire the amount of activity, the heart rate, the blood oxygen level, and the like, and obtain a physical environment of the user more appropriately.

### Configuration of Radio Communication Device

### Second Embodiment

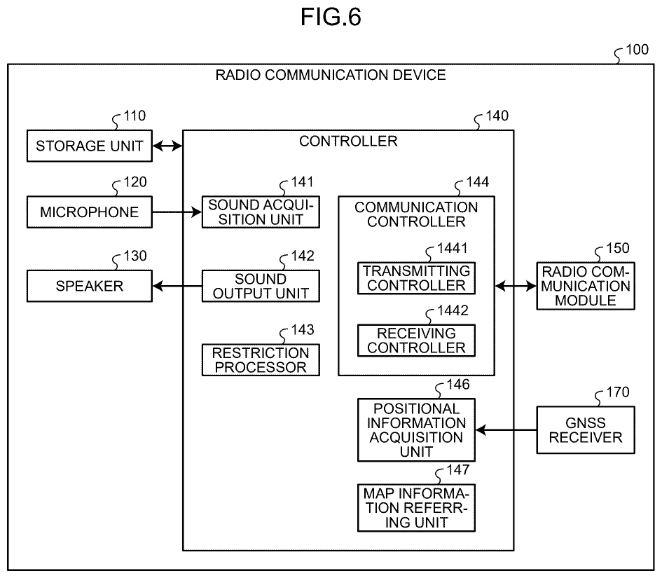

The radio communication device 100 according to a second embodiment will be described next using FIG. 6. FIG. 6 is a diagram illustrating an example of a configuration of a second embodiment of the radio communication device according to the disclosure. The radio communication device 100 according to the second embodiment is the same as the radio communication device 100 according to the first embodiment except that, with respect to the radio communication device 100 according to the first embodiment, the detector 145 is replaced with a positional information acquisition unit 146, the sensor 160 is replaced with a GNSS receiver 170, and a map information referring unit 147 is added to the controller 140. Thus, the positional information acquisition unit 146, the GNSS receiver 170, and the map information referring unit 147 that have different components from those in the radio communication device 100 according to the first embodiment will be described and description of the configurations of other components will be omitted.

The positional information acquisition unit 146 acquires positional information on the radio communication device 100. The positional information acquisition unit 146 has a function serving as the detector 145 and detects a travel speed from a transition in positional information on a person who is walking or running with the radio communication device 100 or on a bicycle that the person is riding. Serving as the detector 145, the positional information acquisition unit 146 detects the user's traveling at the given speed or higher as an environment with a heavy physical load on the user.

In other words, the positional information acquisition unit 146 detects the user's traveling at the given speed or higher in the state of walking or riding a bicycle as an environment with a heavy physical load. For example, in the case where a person is walking with the radio communication device 100, when the travel speed reaches 10 kilometers per hour, it is detected as an environment with a heavy physical load. Note that this numerical value is changeable according to an operation performed by the user. For example, in the case where a person with the radio communication device 100 is riding a bicycle or the case where the radio communication device 100 is mounted on a bicycle, when the travel speed is 30 kilometers or higher, it is detected as an environment with a heavy physical load.

Another example where the positional information acquisition unit 146 functions as the detector 145 is the case where it is represented that a site corresponding to a travel direction based on the transition in positional information on a person who is walking or running with the radio communication device 100 or on a bicycle that the person is riding and corresponding to the current position that is referred to by the map information referring unit 147 to be described below and the travel direction is an uphill.

The map information referring unit 147 refers to map information on an area containing the area corresponding to the positional information that is acquired by the positional information acquisition unit 146. The map information referring unit 147 calculates a travel direction of the radio communication device 100 from the positional information acquired by the positional information acquisition unit 146 and refers to map information on the site corresponding to the travel direction. In this case, the map information contains information on an altitude, a slope, a terrain, etc., in the position on the map. The map information referring unit 147 may cause the storage unit 110 to store map information and may refer to the map information stored in the storage unit 110 or may transmit a request to provide map information to the server device 200 that is external and may refer to map information of the server device 200 that is external.

The GNSS receiver 170 measures positional information on the radio communication device 100. The GNSS receiver 170 includes a global navigation satellite system (GNSS) receiver and, for example, receives radio waves that are transmitted from various positioning satellites, such as a global positioning system (GPS). The GNSS receiver 170 receives radio waves that are transmitted from a plurality of GPS satellites, or the like, and calculates distances to the radio communication device 100 from the GPS satellites using differences each between the time at which radio waves are received and the time at which the GPS satellite, or the like, emits the radio waves, thereby calculating the current position (a longitude and a latitude) of the radio communication device 100.

### Method of Controlling Radio Communication Device

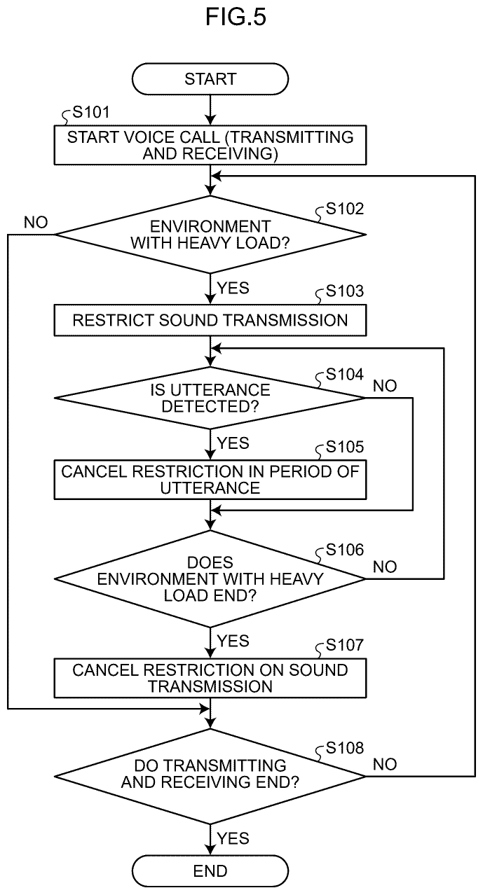

A method of controlling the radio communication device 100 according to the disclosure will be described next using FIG. 5. FIG. 5 is a flowchart illustrating a flow of the method of controlling the radio communication device according to the disclosure. The method of controlling the radio communication device 100 according to the disclosure will be described along the flow illustrated in FIG. 5.

First of all, the radio communication device 100 starts a voice call, in other words, transmitting and receiving sound (step S101). In the process of step S101, a user operates the radio communication device 100 and accordingly communication with another radio communication device 100 is established and an application for performing communication with another radio communication device 100 is started and accordingly a voice call starts.

Tother with the start of step S101, the radio communication device 100 detects whether it is an environment with a heavy physical load (step S102). Specifically, the detector 145 detects whether it is an environment with a heavy physical load on the user of the radio communication device 100. The environment with a heavy physical load on the user of the radio communication device 100 is, as described above, based on detection of climbing an uphill or traveling at a given speed or higher.

A condition for the detector 145 to detect that it is an environment with a heavy physical load on the user of the radio communication device 100 differs according to a mode of use by the user or with respect to each user. As for the mode of use by the user, various modes of use of the radio communication device 100 by the user, such as use in traveling by bicycle, use in climbing mountain or trekking, or use in running, are assumed. The detector 145 may switch the mode of use of the radio communication device 100 by the user according to automatic detection or an operation by the user. The level at which an environment with a heavy physical load is determined may be changeable with respect to each user.

A specific example of the condition for the detector 145 to detect that it is an environment with a heavy physical load on the user of the radio communication device 100 will be presented. The case where the user of the radio communication device 100 is touring by bicycle with another user who is using the radio communication device 100 as well is assumed. In such a case, the detector 145 or the positional information acquisition unit 146 functioning as the detector 145 detects that the user is climbing an uphill, for example, having a gradient of 5% or higher (approximately 2.9 degrees or larger as an angle) as the condition for detecting that the user is climbing an uphill. In this case, the detector 145 may set, for the condition, climbing the uphill of the detected slope continuously, for example, for three minutes or more. The detector 145 may set, for the condition, climbing the uphill of the detected slope continuously, for example, for 50 meters or more. Furthermore, the detector 145 may set, for the condition, climbing the uphill of the detected slope continuously, for example, at a speed of 20 kilometers per hour or higher. In other words, the condition causing a heavy physical load on the user of the radio communication device 100 because of traveling by bicycle and thus excessively increasing respiratory sounds is detected.

The case where the user of the radio communication device 100 is running with another user who is using the radio communication device 100 as well is assumed as another specific example. In such a case, the detector 145 or the positional information acquisition unit 146 functioning as the detector 145 detects climbing an uphill having a gradient of 5% or higher (approximately 2.9 degrees or higher as an angle) as the condition for detecting that the user is climbing an uphill. In this case, the detector 145 may set, for the condition, climbing the uphill of the detected slope continuously, for example, for one minute or more. The detector 145 may set, for the condition, climbing the uphill of the detected slope continuously, for example, for 10 meters or more. Furthermore, the detector 145 may set, for the condition, climbing the uphill of the detected slope continuously, for example, at a speed of 8 kilometers per hour or higher. In other words, the condition causing a heavy physical load on the user of the radio communication device 100 because of traveling by running and thus excessively increasing the respiratory sounds is detected.

The case where the user of the radio communication device 100 is trekking with another user who is using the radio communication device 100 as well is assumed as another specific example. In such a case, the detector 145 or the positional information acquisition unit 146 functioning as the detector 145 detects climbing an uphill having a gradient of 10% or higher (approximately 5.7 degrees or higher as an angle) as the condition for detecting that the user is climbing an uphill. In this case, the detector 145 may set, for the condition, climbing the uphill of the detected slope continuously, for example, for five minutes or more. The detector 145 may set, for the condition, climbing the uphill of the detected slope continuously, for example, for 100 meters or more. Furthermore, the detector 145 may set, for the condition, climbing the uphill of the detected slope continuously, for example, at a speed of 4 kilometers per hour or higher. In other words, the condition causing a heavy physical load on the user of the radio communication device 100 because of traveling by walking, such as trekking, and thus excessively increasing the respiratory sounds is detected.

The condition for determining that it is an environment with a heavy physical load on the user corresponds to, even not with respect to an uphill, the case where the user is traveling by bicycle at a given speed, such as 40 kilometers per hour, furthermore, the case where the time during which the user is traveling by bicycle at the given speed or higher continues, for example, for a given time, such as 5 minutes, or more, the case where the distance the user is traveling by bicycle at the given speed or higher continuously is equal to or more than a given distance, such as 1 kilometer, etc.

The condition further corresponds to, even not with respect to an uphill, the case where, while traveling on foot, when the user runs at a given speed, such as 10 kilometers per hour, or higher, furthermore the case where the time during which the user is running at the given speed or higher continues, for example, for a given time, such as 3 minutes, or more, the case where the distance the user is running at the given speed or higher continuously is equal to or more than a given distance, such as 500 meters, etc.

At step S102, when it is determined that it is an environment with a heavy physical load (Yes at step S102), the radio communication device 100 restricts transmission of sound (step S103). Specifically, the communication controller 144 restricts transmission of sound by the transmitting controller 1441 in the period during which it is determined that it is an environment with a heavy physical load. Next, the radio communication device 100 detects whether the user utters (step S104). Specifically, the restriction processor 143 detects that the user utters from the sound that is acquired by the sound acquisition unit 141.

Detection of utterance of the user performed at step S104 is performed in the period during which it is determined that the physical load on the user is heavy. In addition to utterance of the user, respiratory sounds of the user and external sound are input to the sound acquisition unit 141 from the microphone 120 and therefore it is necessary to detect utterance of the user from the sound that is input. For example, detection is performed on sound in a given volume or more that is detected for a given period, such as 1.0 second, or more, or the like, from the sound that is input from the microphone 120. By performing phonemic analysis, and the like, on the sound that is input from the microphone 120, utterance that is not respiratory sound or external sound may be extracted.

When utterance of the user is detected at step S104 (Yes at step S104), restriction on sound transmission in the period during which the user utters is canceled (step S105). When the process of step S105 is performed after Yes is determined at step S104, for example, a delay of few seconds occurs in some cases after the user utters until the restriction on sound transmission is cancelled. When such a delay occurs, the beginning part of the utterance of the user is not transmitted to another radio communication device 100. In such a case, after utterance of the user is detected, the sound that is acquired by the sound acquisition unit 141 is buffered in the storage unit 110 or an internal memory of the controller 140 and the buffered sound is transmitted, for example, after the delay, such as few seconds.

The radio communication device 100 then detects whether the environment with a heavy physical load ends (step S106). Note that determination on whether the environment with a heavy physical load ends is determination that the various conditions exemplified in the illustration of step S102 are not met. When it is determined that the environment with a heavy physical load ends (YES at step S106), the radio communication device 100 cancels the restriction on sound transmission (step S107). Next, the radio communication device 100 detects whether the voice call, that is, transmitting and receiving sound ends (step S108). Ending the voice call means the case where the user operates the radio communication device 100 and thereby cancels communication with another radio communication device 100 or determining that the voice call ends because the application for communication with another radio communication device 100 ends. When it is determined that transmitting and receiving sound ends (YES at step S108), the radio communication device 100 ends the process.

Note that, at step S102, when it is determined that it is not an environment with a heavy physical load (No at step S102), the radio communication device 100 shifts to step S108 and executes the process of step S108.

At step S104, when it is not determined that utterance of the user is detected (No at step S104), the radio communication device 100 executes the process of step S106.

At step S106, when it is not determined that the environment with a heavy load ends (No at step S106), the radio communication device 100 returns to step S104 and executes the following process. At step S108, when it is not determined transmitting and receiving sound ends (No at step S108), the radio communication device 100 returns to step S102 and executes the following process.

Accordingly, when it is an environment with a heavy physical load, it is possible to restrict transmission of sounds, thereby preventing respiratory sounds of the user, particularly, relatively hard respiratory sounds, large-volume respiratory sounds, or the like, occurring in an environment with a heavy physical load from being transmitted to a partner of communication. It is thus possible to provide the radio communication device 100 and the method of controlling the radio communication device 100 that enable a voice call between users appropriately. Note that, for example, it is appropriate that the function of the disclosure does not run or stops in a state with a heavy physical load, for example, because of a high altitude, such as 1500 meters or more, or in a state with a possibility of occurrence of a physical risk to the user like the case where a heavy physical load continues, for example, for 30 minutes or more. There may be a function of stopping the function of the disclosure according to an operation of the user when it is necessary to keep a voice call between a plurality of users in the case of use in a game, or the like.

### Third Embodiment

The radio communication device 100 according to a third embodiment will be described next. The radio communication device 100 according to a third embodiment has the same configuration as that of the radio communication device 100 illustrated in FIG. 3 or FIG. 6 and has a different function. The difference in function will be described below.

When the detector 145 detects, in addition to sound that is acquired by the sound acquisition unit 141, that the environment of a user is an environment with a heavy physical load on the user, the transmitting controller 1441 that the communication controller 144 includes transmits information indicating that it is an environment with a heavy physical load on the user to another radio communication device 100.

In a period during which the detector 145 detects that the environment of the user is an environment with a heavy physical load on the user, that is, a period during which the information indicating that it is an environment with a heavy physical load on the user is transmitted to the another radio communication device 100, when the sound acquisition unit 141 detects sound of utterance of the user, the transmitting controller 1441 suspends transmission of the information indicating that it is an environment with a heavy physical load on the user. The period during which transmission of the information indicating that it is an environment with a heavy physical load on the user is suspended is the period during which sound of utterance of the user is detected.

The receiving controller 1442 that the communication controller 144 includes receives, in addition to sound that is transmitted from the another radio communication device 100, information indicating that the environment of the user of the another device is an environment with a heavy physical load.

On receiving the information indicating that the environment of the user of the another radio communication device 100 is an environment with a heavy physical load from the another radio communication device 100, the sound output unit 142 restricts output of the sound that is transmitted from the another radio communication device 100 from which the information is transmitted. Restriction on output of the sound in this case is reducing the volume of sound to be output from the sound output unit 142 to the speaker 130 or performing muting such that the sound is not output.

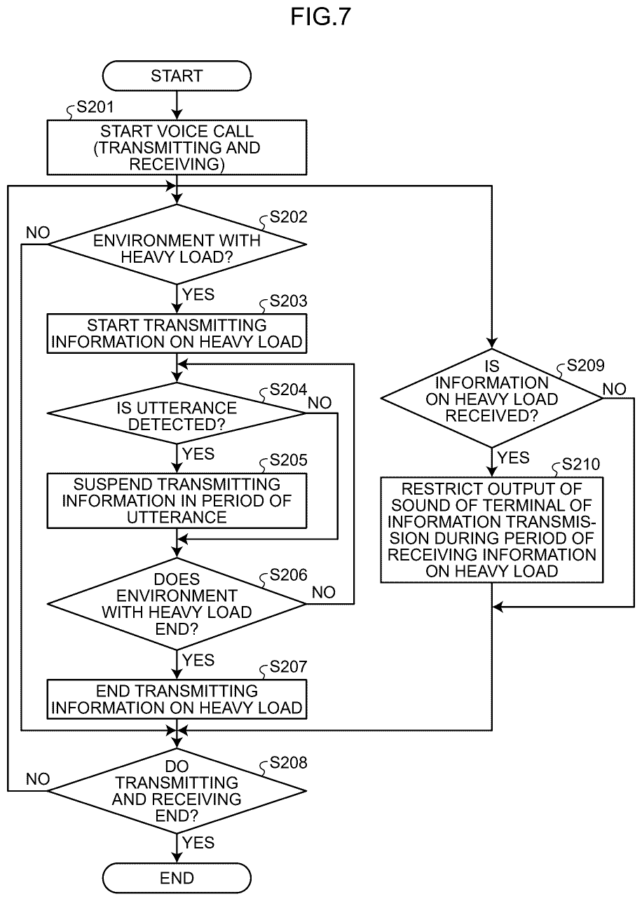

The method of controlling the radio communication device 100 according to the disclosure will be described next using FIG. 7. FIG. 7 is a flowchart illustrating a flow of the method of controlling the radio communication device according to the disclosure. The method of controlling the radio communication device 100 according to the disclosure will be described along the flow illustrated in FIG. 7. The process of steps S201 and S202, step S204, and steps S206 to S208 in FIG. 7 is the same as the process of steps S101 and S102, step S104, and steps S106 to S108 and thus description thereof will be omitted.

When it is determined that it is an environment with a heavy physical load at step S202 (Yes at step S202), the radio communication device 100 starts transmitting information indicating that it is an environment with a heavy physical load to the another radio communication device 100 (step S203). Note that information indicating that it is an environment with a heavy physical load, for example, may be added as a flag to data configuring sound to be transmitted. The information indicating that it is an environment with a heavy physical load may be added to sound to be transmitted in a period during which it is detected that it is an environment with a heavy physical load or may be information indicating the start of detecting that it is an environment with a heavy physical load and information indicating the end at the time when it is not an environment with a heavy physical load. The radio communication device 100 detects whether the user utters next (step S204).

At step S204, when utterance of the user is detected (Yes at step S204), the radio communication device 100 suspends transmitting the information indicating that it is an environment with a heavy physical load in a period during which the user utters (step S205). As for suspension of transmitting the information indicating that it is an environment with a heavy physical load, in the period during which it is detected that it is an environment with a heavy physical load, in the case where the information is added to the sound, the information indicating that it is an environment with a heavy physical load is not added to the sound in the period during which the user utters. In the case where the information indicating the start and the end of an environment with a heavy physical load is added to the sound, information indicating utterance may be added to the sound in the period during which the user utters.

At step S206, when it is determined that the environment with a heavy physical load ends (Yes at step S206), the radio communication device 100 ends transmitting the information indicating that it is an environment with a heavy physical load. Alternatively, the radio communication device 100 transmits the information indicating the end at the time when it is not an environment with a heavy physical load.

The radio communication device 100 performs the process of steps S209 and S210 in parallel with the process of steps S202 to step S207.

The radio communication device 100 determines whether the information indicating that it is an environment with a heavy physical load on the user of the another radio communication device 100 is received from the another radio communication device 100 (step S209). Specifically, it is determined whether the information indicating that it is an environment with a heavy physical load on the user of the another radio communication device 100 is contained in the sound that is acquired from the another radio communication device 100. When the another radio communication device 100 with which the radio communication device 100 is making a voice call includes a plurality of radio communication devices, another radio communication device 100 from which the information indicating that it is an environment with a heavy physical load is transmitted is specified.

At step S209, when it is determined that the information indicating that it is an environment with a heavy physical load on the user of the another radio communication device 100 is received (Yes at step S209), the radio communication device 100 restricts output of the sound that is acquired from the another radio communication device 100 in the period during which the information indicating that it is an environment with a heavy physical load on the user of that radio communication device 100 is received.

At step S210, the period during which output of the sound is restricted is the period for the process of steps S203 to S207 in the another radio communication device 100. When the another radio communication device 100 with which the radio communication device 100 is making a voice call includes a plurality of radio communication devices, output of the sound that is acquired from the another radio communication device 100 from which the information indicating that it is an environment with a heavy physical load is transmitted is restricted.

At step S209, when it is not determined that the information indicating that it is an environment with a heavy physical load on the user of the another radio communication device 100 is received (No at step S209), the radio communication device 100 executes the process of step S208.

Accordingly, when the environment of the user of the another radio communication device 100 is an environment with a heavy physical load on the user, it is possible to restrict output of the sound that is acquired from that radio communication device 100. Thus, it is possible to inhibit respiratory sounds of the another user, particularly, relatively hard respiratory sounds, large-volume respiratory sounds, or the like, occurring in an environment with a heavy physical load from being output. This makes it possible to provide the radio communication device 100 and the method of controlling the radio communication device 100 that enable voice calls between users appropriately. Note that, for example, it is appropriate that the function of the disclosure does not run or stops in a state with a heavy physical load, for example, because of a high altitude, such as 1500 meters or more, or in a state with a possibility of occurrence of a physical risk to the user like the case where a heavy physical load continues, for example, for 30 minutes or more. There may be a function of stopping the function of the disclosure according to an operation of the user when it is necessary to keep a voice call between a plurality of users in the case of use in a game, or the like.

In the process illustrated in FIG. 7, the radio communication devices 100 making a voice call execute the process of steps S202 to S207 and the process of steps S209 and S210 in parallel after the voice call is started at step S201 until No is determined at step S208.

In the process of steps S202 to S207 and the process of steps S209 and S210, the radio communication device 100 may enable switching between validation and invalidation of the process freely. The radio communication device 100 may have a function of steps S202 to S207 and a function of steps S209 and S210 and the radio communication device 100 may have a function of steps S202 to S208 without implementing the function of steps S209 and S210.

For example, when a plurality of users make a voice call using the radio communication devices 100, the radio communication device 100 that the user who plays a role of a leader or a supervisor uses may invalidate the process of steps S209 and S210 or may be without the function of steps S209 and S210.

### Configuration and Effect

The radio communication device 100 according to the disclosure includes the sound acquisition unit 141 that acquires sound that is acquired by the microphone 120 that acquires sound of utterance of a user; the communication controller 144 that transmits the sound that is acquired by the sound acquisition unit 141 to another device that is set previously; the detector 145 that detects that an environment of the user is an environment with a heavy physical load on the user; and the restriction processor 143 that restricts transmission of the sound that is acquired by the sound acquisition unit 141, which is transmission performed by the communication controller 144, when the detector 145 detects that it is an environment with a heavy physical load on the user.

According to this configuration, in the case of an environment with a heavy physical load, it is possible to restrict transmission of the sound and thereby prevent respiratory sounds from being transmitted to a partner of communication. Thus, it is possible to provide the radio communication device 100 that enables a voice call between users appropriately.

The detector 145 of the radio communication device 100 according to the disclosure detects the user's climbing an uphill as an environment with a heavy physical load on the user.

According to this configuration, it is possible to detect the user's climbing an uphill as an environment with a heavy physical load on the user and control transmission of the sound to the partner of communication. Thus, it is possible to provide the radio communication device 100 that enables a voice call between users appropriately.

The detector 145 of the radio communication device 100 according to the disclosure detects the user's traveling at a given speed or higher as an environment with a heavy physical load on the user.

According to this configuration, it is possible to detect the user's traveling at the given speed or higher as an environment with a heavy physical load on the user. Thus, it is possible to provide the radio communication device 100 that enables a voice call between users appropriately.

In addition to transmitting the sound that is acquired by the sound acquisition unit 141 to the another device, the communication controller 144 of the radio communication device 100 according to the disclosure receives sound that is transmitted from the another device and thus makes a voice call with the another device and the detector 145 detects that the environment of the user is an environment with a heavy physical load on the user while the voice call is being made by the communication controller 144.

According to this configuration, it is possible to make a voice call with the another device and detect that the environment of the user is an environment with a heavy physical load on the user while the voice call is being made. Thus, it is possible to provide the radio communication device 100 that enables a voice call between users appropriately.

When the sound acquisition unit 141 detects utterance of the user while transmission of the sound to the another radio communication device 100 is restricted, the restriction processor 143 cancels the restriction on transmission of the sound to the another radio communication device.

According to this configuration, it is possible to cancel the restriction on transmission of the sound to the another radio communication device 100 when utterance of the user is detected while transmission of the sound to the another radio communication device 100 is restricted. Thus, a voice call between users is enabled appropriately even when it is detected that it is an environment with a heavy physical load.

A radio communication method according to the disclosure includes a sound acquiring step of acquiring sound that is acquired by the microphone 120 that acquires sound of utterance of a user; a detecting step of detecting that an environment of the user is an environment with a heavy physical load on the user; and a transmission controlling step of transmitting the sound that is acquired at the sound acquiring step to another device that is set previously and restricting transmission of the sound to the another device when it is detected that it is an environment with a heavy physical load on the user at the detecting step.

According to this configuration, it is possible to restrict transmission of the sound when it is an environment with a heavy physical load. It is possible to prevent respiratory sounds, or the like, from being transmitted to a partner of communication. Thus, it is possible to provide the method of controlling the radio communication device 100 enabling a voice call between users appropriately.

The radio communication device 100 according to the disclosure includes the communication controller 144 that receives, from another device that is set previously, sound that is acquired by a microphone of the another device and information indicating that an environment of the user of the another device is an environment with a heavy physical load on the user; and the sound output unit 142 that outputs the sound that is received by the communication controller 144, wherein the sound output unit 142 restricts output of the sound when the information indicating that it is an environment with a heavy physical load on the user is received.

According to this configuration, it is possible to receive, from the another device, the sound and the information indicating that it is an environment with a heavy physical load on the user and restrict output of the sound that is received by the communication controller 144 when the information indicating that it is an environment with a heavy physical load on the user is received. Thus, it is possible inhibit respiratory sounds of the another user, particularly, relatively hard respiratory sounds, large-volume respiratory sounds, or the like, occurring in an environment with a heavy physical load from being output. The method of controlling the radio communication device 100 according to the disclosure includes a sound receiving step of receiving, from another device that is set previously, sound that is acquired by the microphone 120 of the another device; an information receiving step of receiving, from the another device, information indicating that an environment of a user of the another device is an environment with a heavy physical load on the user; and an output restricting step of outputting the sound that is received at the sound receiving step and an output restricting step of restricting output of the sound when the information indicating that it is an environment with a heavy physical load on the user is received at the information receiving step.

According to this configuration, it is possible to receive, from the another device, the sound and the information indicating that it is an environment with a heavy physical load on the user and restrict output of the sound that is received by the communication controller 144 when the information indicating that it is an environment with a heavy physical load on the user is received. Thus, it is possible inhibit respiratory sounds of the another user, particularly, relatively hard respiratory sounds, large-volume respiratory sounds, or the like, occurring in an environment with a heavy physical load from being output.

According to the disclosure, it is possible to provide a radio communication device and a method of controlling a radio communication device that enable a voice call between users appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A radio communication device comprising:
a sound acquisition unit that acquires sound that is acquired by a microphone that acquires sound of utterance of a user;
a communication controller that transmits the sound that is acquired by the sound acquisition unit to another device that is set previously;
a detector that detects that an environment of the user is an environment with a heavy physical load on the user; and
a restriction processor that restricts transmission of the sound that is acquired by the sound acquisition unit, which is transmission performed by the communication controller, when the detector detects that it is an environment with a heavy physical load on the user.

2. The radio communication device according to claim 1, wherein the detector that detects that an environment of the user is an environment with a heavy physical load on the user and increasing respiratory sounds is detected.

3. The radio communication device according to claim 1, wherein the detector detects the user's climbing an uphill as an environment with a heavy physical load on the user.

4. The radio communication device according to claim 1, wherein the detector detects the user's traveling at a given speed or higher as an environment with a heavy physical load on the user.

5. The radio communication device according to claim 1, wherein, in addition to transmitting the sound that is acquired by the sound acquisition unit to the another device, the communication controller receives sound that is transmitted from the another device and thus makes a voice call with the another device, and
the detector detects that the environment of the user is an environment with a heavy physical load on the user while the voice call is being made by the communication controller.

6. The radio communication device according to claim 1, wherein, when the sound acquisition unit detects utterance of the user while transmission of the sound to the another device is restricted, the restriction processor cancels the restriction on transmission of the sound to the another device.

7. A method of controlling a radio communication device, the method comprising:
acquiring sound that is acquired by a microphone that acquires sound of utterance of a user;
detecting that an environment of the user is an environment with a heavy physical load on the user; and
transmitting the sound that is acquired at the acquiring to another device that is set previously and restricting transmission of the sound to the another device when it is detected that it is an environment with a heavy physical load on the user at the detecting.

8. A radio communication device comprising:
a communication controller that receives, from another device that is set previously, sound that is acquired by a microphone of the another device and information indicating that an environment of the user of the another device is an environment with a heavy physical load on the user; and
a sound output unit that outputs the sound that is received by the communication controller,
wherein the sound output unit restricts output of the sound when the information indicating that it is an environment with a heavy physical load on the user is received.

9. The radio communication device according to claim 8, wherein the detector that detects that an environment of the user is an environment with a heavy physical load on the user and increasing respiratory sounds is detected.
